(19) United States
(12) Patent Application Publication
(10) Pub. No.: US 2004/0157532 A1
(43) Pub. Date: Aug. 12, 2004

(54) Glass-like polysaccharides

(76) Inventors: George Koutlakis, Greenfield Park (CA); Cameron L. Drake, Knoxville, TN (US)

Correspondence Address: KIRKPATRICK & LOCKHART LLP, 535 SMITHFIELD STREET, PITTSBURGH, PA, 15222, US

(21) Appl. No.: 10/757,266

(22) Filed: Jan. 14, 2004

Related U.S. Application Data
(60) Provisional application No. 60/439,791, filed on Jan. 14, 2003.

(51) Int. Cl. C09K 3/14; B24B 1/00; C08L 5/00; C08L 3/02; C09J 103/02

(52) U.S. Cl. 451/32; 51/302; 106/205.01; 106/206.1; 451/35

(57) ABSTRACT

The present invention relates to novel glass-like polysaccharides, a method of treating a substance with a glass-like polysaccharide, and methods of producing these glass-like polysaccharides.

### CROSS REFERENCE TO RELATED APPLICATION

This application claims priority to U.S. Provisional Patent Application Serial No. 60/439,791, entitled “Glass-Like Polysaccharides”, filed Jan. 14, 2003, which is incorporated by reference herein in its entirety.

### BACKGROUND OF THE INVENTION

1. Field of the Invention

The present invention relates to glass-like polysaccharide fragments useful for treating substances.

2. Related Art

Glass-like polysaccharides are well known in the art. These compositions are commonly formulated into abrasive grits for use as blast media in sand blasting operations, or fine particulates for use as absorbents in items such as diapers.

U.S. Pat. Nos. 5,066,335, 5,360,903, and 5,367,068, describe glass-like polysaccharide abrasive grits and methods for using these grits as blast media to treat surfaces. U.S. Pat. No. 6,159,257 describes a glass-like polysaccharide abrasive grit that addresses a shortcoming of previously described grits, namely, water absorption. U.S. Pat. No. 6,444,653 and U.S. patent application Pub. No. 2002/0156048 A1, describe glass-like polysaccharide particulate that is useful as an absorbent for liquids.

In the materials processing industry, after the initial shaping of the product occurs, there are typically several finishing steps that are performed on the product prior to final inspection and packaging for the consumer. The initial shaping often results in slight imperfections that need to be subsequently removed. Additionally, the initial shaping often uses a “wet” step, such as liquid lubricated saw, grinding wheel, drill, or milling machine, or a liquid lubricated abrading or polishing step. Prior to any subsequent manufacturing steps, the liquid must be removed.

In the parts manufacturing industry, after the initial casting, molding, machining, stamping, cutting or other manufacturing process that would be used by one of skill in the art to create the desired part, finishing steps are often performed to further modify the product and correct or remove minor imperfections. Additionally, it is often desired to impart a particular finish on the parts after they are created, such as a high luster or a matte finish, a roughened finish that will retain oils or other liquids more efficiently, or simply to clean or degrease the parts prior to packaging. Typical casting techniques such as investment casting, lost wax casting, ceramic shell casting, sand casting or die casting result in frequent superficial imperfections on the cast part. Modern CNC machining or milling techniques also result in imperfections of the machined part. Examples of imperfections would be burrs, flash, scale, oxidation, discoloration, or other minor surface imperfections that would be readily apparent to one skilled in the art.

During these finishing steps, the parts are typically placed in a vibratory, a barrel, or centrifugal finishing apparatus along with a particulate composition and often a liquid. The particulates used are selected based on the desired final characteristics of the finished part. Examples of particulates used are aluminum oxide grits, silicon carbide grits, glass beads, crushed glass, steel shot, steel grit, ceramic shot, silica sand and plastics. Plastic, steel, and ceramic offer the most versatility, as they can be created in numerous different shapes to achieve a desired finish. Plastics are often the material of choice, as they can be cheaply and easily formulated into desired shapes and hardnesses to impart different finishing characteristics on a chosen material.

Often these finishing steps are performed in the presence of a liquid, such as water or different oils, thus necessitating a further drying step after the finishing steps, using a drying agent in a vibratory or centrifugal finishing apparatus. The drying step prepares the finished part for inspection and packaging, and can also prevent corrosion or other damage to the final product—e.g. water spotting caused by minerals in the water. Ground corncobs, ground walnut shells, sawdust and wood chips are current materials used as drying agents. Often, these agents are combined with circulating or forced air, which is optionally heated, to facilitate the drying process.

One of the shortcomings with using the current drying agents and particulates in the finishing steps of manufacturing procedures is in the generation of fugitive dust. This dust not only creates a dirty work environment which can result in lower quality of finished products, but also health hazards for employees working in the work environment. This can further impact whether a facility will meet the stringent guidelines and criteria set forth for gaining and maintaining ISO 9000 and ISO 14000 certification.

Further, many of these particulates are not biodegradable, thus when their useful work life has past, they add to the current waste disposal issues that face society. The biodegradable products that are presently in use, such as corncobs, break down rapidly during use. Not only does this reduce their effective work life, it also produces large amounts of dust in the work area and on the work pieces. Additionally, these biodegradable products cannot withstand high drying temperatures, often resulting in longer process times.

Another shortcoming is that many of the agents do not serve the dual purpose of acting as both a drying agent and an abrasive agent. Typically the media that acts as an abrasive is not an absorbent material. This results in more processing steps, which in turn can lead to increased production costs and greater possibilities of manufacturing errors.

There exists a need for an agent that improves upon these deficiencies, and the glass-like polysaccharides of the invention fulfill this need.

### BRIEF SUMMARY OF THE INVENTION

It is a general object of the invention to provide a method of treating a substance with a glass-like polysaccharide.

It is specific object of the invention to provide a method of treating a substance with a glass-like polysaccharide, wherein said treating comprises placing said substance in contact with said glass-like polysaccharide, and agitating for a period of time to produce a modified substance.

It is another general object of the invention to provide a process for producing chemically cross-linked, polysaccharide fragments.

It is another specific object of the invention to provide a process for producing chemically cross-linked, polysaccharide fragments comprising the steps of:

(a) heating a homogeneous, aqueous mixture of dispersed polysaccharide molecules produced from starch and a chemical cross-linking agent to anneal the mixture whereby at normal ambient temperatures the mixture forms a solid product having a moisture content of between about 10 to about 70% by weight;

(b) reacting the chemical cross-linking agent with said polysaccharide molecules to produce intermolecular chemical cross-linkages between the polysaccharide molecules; and

(c) processing the solid product obtained thereby to form fragments having an apparent hardness of between about 1.0 moh and about 4.0 moh and sizes ranging between about 6.0 mm to about 100.0 mm.

It is a further specific object of the invention to provide a process for producing glass-like polysaccharide fragments comprising the steps of:

(a) providing an aqueous dispersion of polysaccharides produced from starch, said dispersion having an average amylose content ranging from between about 40% to about 90% by weight;

(b) heating said dispersion at a temperature and for a time sufficient to form a gel;

(c) subdividing and cooling the gel to form a glass-like solid material; and

(d) grinding the glass-like solid material to form glass-like polysaccharide fragments having an apparent hardness of between about 1.0 moh and about 4.0 moh, an average moisture content of at least about 5%, and sizes ranging between about 6.0 mm to about 100.0 mm.

It is another general object of the invention to provide an isolated product comprising polysaccharide fragments.

It is another specific object of the invention to provide an isolated product comprising chemically cross-linked polysaccharide fragments or polysaccharide fragments having an average amylose content between about 45% and about 95% by weight, having a moisture content between about 5% and about 70% by weight, an apparent hardness between about 1.0 moh and about 4.0 moh, and fragment sizes ranging from between about 6.0 mm to about 100.0 mm.

### DETAILED DESCRIPTION OF THE PREFERRED EMBODIMENTS

The present invention relates to a method of treating a substance with a glass-like polysaccharide, wherein said treating comprises placing said substance in contact with said glass-like polysaccharide, and agitating for a period of time to produce a modified substance.

By “treating,” is meant placing the substance to be treated in contact with the glass-like polysaccharide of the present invention, and agitating until the desired effect on the substance to be treated is achieved.

By “substance,” is meant any composition of matter that can be acted upon by the glass-like polysaccharide of the present invention.

By “placing said substance in contact with,” is meant placing the glass-like polysaccharide of the present invention in physical contact with the substance being treated.

By “agitating,” is meant imparting motion, as set forth herein, to the glass-like polysaccharide, the substance being treated, or a combination thereof, and includes fluidized forms of motion, such as, for example, by rotational mixing or tumbling, but does not include imparting highly pressurized or accelerated forms of motion to the glass-like polysaccharide, such as, for example, by sand blasting. For example, this can be a single motion of limited energy, or repetitive motions of high frequency and energy. The motion can occur over short or long durations of time.

By “removal of liquid,” is meant drying the substances being treated. In one embodiment, the drying is removal of liquid from the surface of the substance being treated. In another embodiment, the drying is removal of total liquid content from the substance being treated. In one embodiment, the liquid is water, however, other liquids, such as oils, chemical or the like are within the meaning of this term.

By “modifies the form or finish,” is meant altering the surface of the substance being treated. This altering can be removing liquid from the surface, removing dirt or other residue from the surface, deburring, degrading, abrading, grinding, sanding, polishing, buffing, cleaning, degreasing, burnishing or other alterations of the surface. This term can also be construed to mean altering the shape of the substance being treated, for example, rounding off sharp edges.

In one embodiment of the invention, the substance is treated in such a way as to modify the form or finish of the substance. Examples include, but are not limited to, treatment of the substance such that the substance is deburred, burnished, polished, cleaned, strengthened, prepared for anodization, prepared for painting, prepared for electroplating, or that the substance has improved oil or other liquid retention on its surface.

In another embodiment, the substance is treated in such a way that the removal of liquid from said substance results. In one embodiment, this removal of liquid is the removal of water from the surface of the substance being treated. In another embodiment, the removal of liquid is the removal of manufacturing chemicals from the surface of the substance being treated. In another embodiment, the removal of liquid is the removal of oils from the surface of the substance being treated.

In a further embodiment, the substance is brought into contact with said glass-like polysaccharide in an apparatus selected from, but in no way limited to, the group consisting of a vibratory mill, a ball mill, an agitator mill, an attrition mill, a roller ball mill, a bead mill, a planetary mill, and a sand mill, a vibratory finisher, a vibratory bowl finisher, a vibratory tub finisher, a centrifugal finisher, a centrifugal disc finisher, a centrifugal barrel finisher, a spindle finishing machine, a drag finishing machine, a tumbler, a barrel tumbler, a burnisher, and a racetrack finisher.

Vibratory finishing is a commonly used mass finishing technique that, in contrast to hand finishing techniques, does not rely on a large degree of operator skill. Vibratory finishing typically produces uniform finishes for the materials treated in the same lot. Parts are loaded into the vibratory finishing machine with a media or medias of choice, such as the glass-like polysaccharide of the claimed invention. During the course of operation, the vibrating action from the apparatus causes the media to move against the substance being treated, resulting in the removal of liquids from the substance being treated, or modification of the form or finish of the substance being treated. This modification is largely dependent on the relative hardness of the treated substance as compared to the relative hardness of the media used. If the relative hardness of the substance being treated is greater than the finishing media, only minor modifications to the substance will be achieved. This may be desired, however, particularly if the finishing media is only being used as a drying media to remove residual moisture, chemicals, oils or other liquids from the substances being treated. Time cycles for this finishing technique typically range from 1 to 24 hours, however, these times can be lengthened or shortened depending upon the desired end finish of the substance being treated.

Barrel finishing is another commonly used mass finishing technique that utilizes a barrel rotating about its horizontal axis. The substances to be treated are loaded into the barrel along with a finishing media, such as the glass-like polysaccharide of the invention. Optionally, liquid media can be added if a wet processing step is desired. The shape of the barrel can be varied to achieve differing effects on the substances being treated, with octagonal and hexagonal barrels being the most common shapes used. Amounts of media added to the barrel, and rotation speed, determine how the treatment modifies the substance being treated. Although vibratory finishers are more commonly used, barrel finishers tend to perform better on flat parts that need to be kept separated during the processing and mass finishing techniques. Time cycles for this finishing technique typically range from 1 to 24 hours, however; these times can be lengthened or shortened depending upon the desired end finish of the substance being treated.

It can be conceived that the glass-like polysaccharide grit of the invention can be used to treat any substance. In one embodiment, the substance to be treated comprises a metal. Examples of metals that can be treated by the glass-like polysaccharide of the invention, but not limited to, are steel, stainless steel, iron, nickel, nickel alloys, aluminum, aluminum alloys, scandium, copper, titanium, zinc, scandium, nickel, tungsten carbide, lead, gold, silver, platinum, beryllium, tin, brass, bronze, and any other alloys or mixtures thereof.

In another embodiment, the substance to be treated comprises a plastic.

Examples of plastics that can be treated by the glass-like polysaccharide of the invention, but not limited to, are polypropylene, polystyrene, polyvinychloride (PVC), acrylonitrile butadiene styrene (ABS), cellulose, acrylic, polyester, polycarbonate, acetyl, nylon, polyethylene, flouropolymers, polyphenylene oxide, polysulfone, polyetheretherketone (PEEK), polyetherimide, polyamide-amide, polyimide, PBI, fiberglass and garolite.

In a further embodiment, the substance to be treated comprises a composite material. Examples of composite materials that can be treated by the glass-like polysaccharide of the invention, but not limited to, are carbon fiber composites, kevlar fiber composites, boron fiber composites, and fiberglasses.

In another embodiment, the substance to be treated comprises a rubber. Examples of rubbers that can be treated by the glass-like polysaccharide of the invention, but not limited to, are latex, pure gum rubber, nitrile, styrene-butadiene rubber, neoprene, epichlorohydrin, butyl, EPDM, hypalon, silicone rubber, polyurethane, santoprene, vinyl and viton.

In a further embodiment, the substance to be treated comprises a glass. Examples of glasses that can be treated by the glass-like polysaccharide of the invention, but not limited to, are borosilicate glass, silica glass, glass-ceramic, soda lime glass.

In another embodiment, the substance to be treated comprises a ceramic. Examples of ceramics that can be treated by the glass-like polysaccharide of the invention, but not limited to, are glass-mica ceramic, alumina bisque ceramic, boron-nitride ceramic, garolite-laminated ceramic, high alumina ceramic, zirconia ceramic, zirconium phosphate ceramic, alumina ceramic, silica ceramic, zirconium oxide ceramic, and silicon-nitride.

In a further embodiment, the substance to be treated comprises a mineral. Examples of minerals that can be treated by the glass-like polysaccharide of the invention, but not limited to, are precious or semi-precious stone, such as diamonds, rubies, sapphires, emeralds, topazes, jade, amethyst, azurite, beryl, quartz, tourmaline, opal, turquoise.

In another embodiment, the substance to be treated is brought into contact with the glass-like polysaccharide of the invention to remove liquid from the substance being treated. In one embodiment, the liquid is residual moisture on the surface of the substance to be treated left over from the manufacturing process, and the glass-like polysaccharide of the invention acts as a drying agent when brought into contact with this substance. In another embodiment, the liquid is residual oils or chemicals from the manufacturing process and the glass-like polysaccharide of the present invention absorbs these liquids, yielding a substantially dry substance. In another embodiment, the glass-like polysaccharide of the invention dries the substance to be treated, substantially removing liquid from the surface of the substance being treated. In another embodiment, the glass-like polysaccharide of the invention can be used in combination with air, optionally heated, that is directed or circulated over, into, or through the glass-like polysaccharide of the invention mixed with the substance to be treated.

In a further embodiment, the substance to be treated is brought into contact with the glass-like polysaccharide of the invention to modify the form or finish of the substance to be treated. Modifying the form or finish can be exemplified by, but is in no way limited to, deburring, degrading, abrading, grinding, sanding, polishing, buffing, cleaning, degreasing, burnishing and other treatments that would be apparent to one skilled in the art.

In another embodiment, the substance to be treated is brought into contact with the glass-like polysaccharide of the invention in the presence of other media used to treat substances. One advantage of combining the glass-like polysaccharide of the invention with other media during the treatment process is that several steps can be combined into one step. For example, abrading, drying and polishing of a substance could be achieved in a single step, resulting in tremendous cost savings. Examples of other media, but not limited to, are aluminum oxide grits, silicon carbide grits, glass beads, crushed glass, steel shot or ball bearings, steel grit, other metallic shot, ball bearings or grit, corncob, walnut shells, plastics, ceramic shot or ball bearings, baking soda, novaculite, and silica sand. Further examples of other media are dry polishing compounds, wet polishing compounds, and polishing creams can be added to the mixture to further modify the finish of the substance being treated.

These media are often available in different shapes, particularly the metallic, plastic and ceramic media. The different shapes exert differing effects on the substance being treated, and choice of these shapes would be apparent to one skilled in the art. Examples of shapes of other media, but not limited to, are cones, tetrahedrons, cylindrical wedges, pyramids, wedges, tri-stars, triangles, spheres, ballcones, diagonals, eclipses, ovalballs, pins, or others that would be readily apparent to one skilled in the art.

The present invention further relates to an isolated product comprising chemically cross-linked polysaccharide fragments or polysaccharide fragments having an average amylose content between about 45% and about 95% by weight, having a moisture content between about 5% and about 70% by weight, an apparent hardness between about 1.0 moh and about 4.0 moh, and fragment sizes ranging from between about 6.0 mm to about 100.0 mm.

Sugars and polysaccharides are the two main classes of carbohydrates. As set forth in “Organic Chemistry” Vol. 1:I. Finar; Longmans, Green and CO.; 3^{rd} edition, 1959, sugars include monosaccharides and oligosaccharides, with the latter in turn consisting of the disaccharides, trisaccharides and tetrasaccharides. Polysaccharides on the other hand are a chemically distinct class of carbohydrate polymers that contain at least five and usually a very great number of repeating saccharide units. The pentosans are an example of one class of polysaccharide and are based on repeating pentose units. More commonly, polysaccharides are based on larger repeating saccharide units in polymeric form, as in the case of starches, and celluloses both of which are based on repeating hexose units.

Sugars are not commercially suited to use in the method of the present invention primarily because their crystalline structures readily fragment on impact and are not reusable once the grit size becomes too reduced as a consequence. By way of comparison to sugar, the glass-like polysaccharides useful in the method of the present invention have mechanical properties which result in greater fragment or particle integrity.

In one embodiment of the present invention, the glass-like polysaccharide is based on an amylaceous polysaccharide, such as amylose and amylopectin or mixtures of the two. Accordingly, glass-like polysaccharides, herein, include those produced from starches such as corn, milo, wheat, barley, rye, potato, or other starches. The preferred starch is wheat starch; prime or “A” grades are especially preferred. Both the selection of the starch and any modifications made thereto will affect the properties of the glass-like material. The length and branching of the polymer chains that are genetically predetermined and unique to any given unmodified starch, or which are the result of changes brought about in consequence of any modification of the starch, will have effects on the amount of, for example, hydrogen bonding and ven der Waals forces (amongst others), which play a role in formatting the above-mentioned glass-like polysaccharides. Thus, starches that have been hydrolytically modified from glass-like materials which are generally more brittle than are otherwise comparable-glass-like materials based on unhydrolysed starch. Accordingly, while the method of the present invention extends to the use of glass-like polysaccharides produced from starch hydrolysates, it is preferred that the starches have a dextrose equivalent ranging between about 0 and about 25. More preferably, the starch has a dextrose equivalent ranging between about 0 and 10, and most preferred are starches which are substantially unhydrolysed, (i.e. having a dextrose equivalent ranging between about 0 and about 1). The starches may also have a dextrose equivalent ranging between 0 and 25, between 0 and 10, and starches which are substantially unhydrolysed, (i.e. having a dextrose equivalent ranging between 0 and 1).

The moisture content of the glass-like polysaccharide affects apparent hardness and integrity of the material. In a preferred embodiment, the moisture content of starch-based glass-like polysaccharides is between about 5% and about 70%, more preferably between about 5% and about 40%, and even more preferably in the range between about 20% to about 25%. The moisture content of starch-based glass-like polysaccharides may also be between 5% and 70%, more preferably between 5% and 40%, and even more preferably in the range between 20% to 25%. In general, the more water that is present in the glass-like polysaccharide the greater the resiliency of the resulting material (with a lower apparent hardness), and the less aggressive grits based on such materials will be in, for example, removing a coating from a surface. On the other hand, the lower the moisture content the more generally brittle the material is likely to be, with a resultant loss of particle integrity and a greater rate of particle breakdown and hence higher grit costs to the user. Moreover, although moisture contents of less than 10% or even less than 5% are possible, the production of such products may result in thermal hydrolysis of the product, which is not generally desirable.

In a preferred embodiment, the hardness of the glass-like polysaccharide of the present invention ranges between about 1.0 moh and about 4.0 moh, between about 2.0 moh and about 4.0 moh, between about 3.0 moh and about 4.0 moh, between about 1.0 moh and about 3.0 moh, and between about 1.0 moh and about 2.0 moh. Further, these hardness ranges can be between 1.0 moh and 4.0 moh, between 2.0 moh and 4.0 moh, between 3.0 moh and 4.0 moh, between 1.0 moh and 3.0 moh, and between 1.0 moh and 2.0 moh. The hardness value of the glass-like polysaccharide of the present invention based on the moh scale of harness can be converted to equivalent values of other hardness scales used by those skilled in the art, such as the Brinnell scale, the Knoop scale, or the Vicker scale.

Starches in their native state have the form of granules of various sizes and shapes, and the amylaceous molecules that are bound in this granular structure must be dispersed in solution in the course of preparing glass-like starches. The process for carrying out this dispersion is well known in the starch industry as “gelatinization”. In general, gelatinization entails heating an aqueous mixture of starch granules to a temperature at which the granules breakdown and the individual starch molecules disperse into solution. Typically, this is carried out in the course of producing the glass-like starch-based materials useful herein.

Materials useful herein are exemplified by those disclosed in previously mentioned U.S. Pat. No. 3,706,598 and AU 74083/87. Other similar glass-like starches are also known, and are useful for the purposes of the method of the present invention. These can be prepared without undue experimentation and development, in accordance with known processes, existing skill in the art and having regard for the disclosure of the present specification.

The present invention further relates to a process for producing a chemically cross-linked, glass-like polysaccharide, and in particular to a process for producing glass-like starch-based materials, comprising the steps of:

(a) heating a homogeneous, aqueous mixture of dispersed starch molecules and a chemical cross-linking agent to anneal the mixture whereby at normal ambient temperatures the mixture forms a (normally transparent or translucent) glass-like solid;

(b) reacting the chemical cross-linking agent with at least some of the starch molecules to produce intermolecular chemical cross-linkages between the starch molecules.

The increased structure attributable to cross-linking generally increases the apparent hardness of the glass-like material and improves the aggressiveness of abrasive grits produced therefrom. There are indications, however, that there may be a concomitant decrease in the integrity of such grit materials, particularly when the grit is prepared using an extrusion process. It is believed that this occurs as a consequence of an increase in the viscosity of the aqueous mixture, due to ongoing cross-linking. In the extrusion process, the glass-like polysaccharide generally can be processed faster and at slightly lower processing temperatures through the use of mechanical shear in an extruder. Notwithstanding the other benefits of extrusion processing, the effect of the shearing action on the cross-linking polysaccharide with its increasing viscosity, is to increase the shear rate and hence subdivide the molecular structures based on the interpolymeric physical bonding, and the polymer chains themselves, all of which results in a loss of particle integrity. The problem is exacerbated in the presence of a cross-linking catalyst, such as calcium carbonate for example.

The use of sodium hydroxide, or other source of hydroxyl ions in mixtures which do not contain cross-linking agents helps to reduce the viscosity of the aqueous mixture. In mixtures which contain cross-linking agents, however, the addition of hydroxyl agents initiates the cross-linking reaction, and actually leads to an increase in the viscosity of the mixture. Moreover the addition of caustic, while reducing the amount of breakdown of particles in use, also significantly reduces the aggressiveness of the particles.

It is contemplated that the problems associated with the extrusion of at least partially cross-linked, high viscosity, aqueous mixtures can be minimized by incorporating the cross-linking agent into the mixture without activating it. In this way the cross-linking reaction is postponed, preferably until the processing of the glass-like polysaccharide is otherwise substantially complete.

Higher moisture content also helps to prevent an excessively high viscosity, especially in the case of extrusion of the cross-linked glass-like polysaccharide, and starch-based products having about 25% moisture are preferred.

The present invention further relates to a process comprising the steps of:

(a) heating a homogeneous, aqueous mixture of dispersed polysaccharide molecules and a chemical cross-linking agent, to anneal the mixture whereby at normal ambient temperatures the mixture forms a glass-like solid;

(b) reacting the chemical cross-linking agent with at least some of the polysaccharide molecules to produce intermolecular chemical cross-linkages between the polysaccharide molecules after the mixture has formed into the glass-like solid.

This can be accomplished, inter alia, by exposing the compositions that are so produced to a gaseous source of hydroxyl ions, which in turn initiate the cross-linking reaction. In this way, the surface, up to the depth to which the hydroxyl ions penetrate, undergoes cross-linking.

The occlusion of the moisture content within the glass-like starch materials described hereinabove results in these glass-like products being non-expandable using normal commercial methods associated with the production of, for example, the “half products” which are the subject of the abovementioned AU 74083/87 patent document. In general, glass-like starch products are physically distinguishable from expanded and puffed starch products by virtue of the glasslike products not having any significant number of substantial gas voids therein. In addition to not being expanded, glass-like starch-based materials in which the moisture is substantially occluded within the starch matrix strongly resist expansion. By way of example, a product according to the present invention does not expand substantially after exposure to 2450 MHz microwaves at a power of 720 watts for five minutes. This occlusion of moisture distinguishes such products from those glass-like starch-based materials previously known in the art, including those disclosed in U.S. Pat. No. 3,706,598 and AU 74083/87.

According to the Australian publication, such products have three basic applications, namely as: snack foods, breakfast cereals, and instant products. These previously known products depend on the fact that the moisture content thereof, while residing in the glass-like starch matrix, is not substantially occluded and can be volatilized and released on exposure to, for example, microwaves, so as to produce a puffed (a.k.a. expanded) product. The U.S. patent relates to the production of glass-like starch hydrolysates having a dextrose equivalent of between 10 and 25, which are useful in dehydrated foods as bulking agents/humectants or as additives to soups or sauces, and which are readily dispersible in water. In order to meet the dispersability/solubility requirements, these products are at least partially hydrolysed and consequently are mechanically weakened, in such a way that the water residing in the matrix is not occluded. In both cases the desired properties are related to the production of glass-like starches in which the internal structure of the product is sufficiently underdeveloped or disrupted so as to allow water to be rapidly absorbed on the one hand, or rapidly released upon heating on the other hand.

Glass-like starches in which the moisture is substantially occluded are preferably based on starches having a dextrose equivalent of less than 10. These starches are preferably substantially unhydrolysed.

The present invention further relates to a process for producing a solid glass-like starch-based material comprising the steps of heating a homogeneous, aqueous mixture of dispersed starch molecules, sufficiently to anneal the mixture into a glass-like solid upon cooling thereof, and without substantial volatilization of the moisture following formation of a matrix of starch molecules therein, whereby the moisture contained in the mixture is substantially occluded within the matrix of starch molecules.

In a preferred embodiment, the mixture can be heated to between 40 and 150 degrees C. Wherever temperatures in excess of the boiling point of water in the mixture are used, then the process should be carried out under pressure to preclude damage or destruction of the matrix at any time from its incipient formation, until the material is annealed in the form of a glass-like solid. In general extrusion processing allows higher product temperatures to be employed, through heating and mechanical working, and this expedites the production process. Moreover, the product which results from the extrusion process is generally more uniform than products produced using, for example, batch processing.

In a further embodiment, the present invention relates to a process for extruding a solid glass-like polysaccharide comprising the steps of extruder heating and shearing a homogeneous, aqueous mixture of dispersed starch molecules, sufficiently to anneal the mixture into a substantially uncrystallized, glass-like solid upon cooling thereof, and without substantial volatilization of the moisture following formation of a matrix of starch molecules therein, whereby the moisture contained in the mixture is substantially occluded within the matrix of starch molecules. In this embodiment the mixture typically need only be heated to between 80 and 110 degrees C. The use of an extruder permits controlled heating through the use of independently controlled heating (and cooling) zones. In one embodiment for example, the heating is carried out in a plurality of heating zones, as in the case of one of the examples described elsewhere herein, and according to which the heating is carried out in three heating zones, heated to temperatures of 0 to 50, 50 to 150, and 50 to 150 degrees C., respectively. The rate of product throughput will influence the amount of heat transferred from or to these zones to or by the product and will depend on the size of the extruder in use.

Excessive mechanical working of the products of the present invention can adversely affect the ability of the polysaccharide matrix to hold the water in a substantially occluded condition. Accordingly, the specific mechanical energy input to the mixture during extruder heating and shearing is preferably between 0.05 and 0.2 Kw/kg.

The process of the invention can be further distinguished in that where, following heating and shearing the mixture exits through an opening in a die, it expands to not substantially more than twice the dimensions of the die opening. By way of example, the die opening described in Example 4 is circular and has a diameter of about 4 mm. In use in conjunction with the present invention, the diameter of the mixture (6-8 mm) after passing therethrough is not substantially greater than twice the diameter of the circular die opening. Other sizes or shapes of the die opening can be used, depending upon the final intended use of the composition. For example, but not limited to, die opening diameters ranging between about 5.0 mm to about 100 mm can be used. Further, in addition to circular openings in the die, other shapes, such as, oval, square, triangular, star, diamond, or any other desired shape may be used.

In another embodiment of the present invention, there is provided a product comprising a solid, annealed, chemically cross-linked, glass-like polysaccharide, preferably starch-based and substantially uncrystallized, (normally transparent or translucent) and which remains solid under standard ambient temperature and pressure conditions. Accordingly, there is provided a glass-like polysaccharide including a minor effective amount of a chemical cross-linking agent such as for example a minor effective amount up to about 0.2%, typically between 0.01% and 0.2% and preferably between 0.033% to 0.066% of a cross-linking agent, such as epichlorhydrin, sodium tripolyphosphate or sodium trimetaphosphate, for example, by weight of starch on a dry basis.

The present invention further relates to a process for producing glass-like polysaccharide fragments comprising the steps of:

(a) providing an aqueous dispersion of polysaccharides produced from starch, said dispersion having an average amylose content ranging from between about 40% to about 90% by weight;

(b) heating said dispersion at a temperature and for a time sufficient to form a gel;

(c) subdividing and cooling the gel to form a glass-like solid material; and

(d) grinding the glass-like solid material to form glass-like polysaccharide fragments having an apparent hardness of between about 1.0 moh and about 4.0 moh, an average moisture content of at least about 5%, and sizes ranging between about 6.0 mm to about 100.0 mm.

In one embodiment of the present invention, a process is described for producing abrasive water-resistant glass-like polysaccharide grit particles made from a starch having an average amylose content of at least 45% and having an apparent hardness of up to about 4.0 moh, which provides distinct advantages when compared to the prior art. As used herein, the term water-resistant means that the composition produced maintain their integrity after contact with liquid water for an extended period.

The compositions produced by the process using high amylose starches have superior water-resistance and other advantageous properties when compared to compositions produced from typical starches, such as common corn starches and common wheat starches.

As described in “Organic Chemistry” 3rd ed., Morrison & Boyd, Allyn & Bacon, Inc. (1973), polysaccharides are naturally occurring polymers, consisting of as many as hundreds or even thousands of monosaccharide units per molecule. One of the most important polysaccharides is starch. Starches are comprised of two fractions, amylose and amylopectin. Amylose consists of long linear chains of repeating D-(+) -glucose units, while amylopectin has a highly branched structure consisting of short chains of about 20-25 D-glucose units each.

In general, starches contain about one-quarter amylose and three-quarters amylopectin. For example, typical starches derived from commonly cultivated corn have an amylose content of about 28%, while common wheat starches have an amylose content of about 26%. It is such typical starches which are described as the starting materials for making the abrasive grits of U.S. Pat. No. 5,367,068.

However, some genetically engineered plant strains produce starches with high amylose content. It has been determined that when such genetically engineered, high amylose starches are used to produce abrasive grit particles, the resulting grit particles exhibit surprisingly improved and advantageous characteristics in comparison to grit particles produced from typical starches.

In particular, it has been found that when starches having a high amylose content, such as at least 45% amylose are used, grits produced from them have improved water-resistance and other advantageous properties. For example, Hylon V and Hylon VII (National Starch Company), starches derived from genetically engineered strains of corn, having amylose contents of about 55% and about 70%, respectively, produce highly advantageous compositions in accordance with the present invention. Class IX starch has an amylose content of about 90%. Other varieties of starch, such as pea starches having an amylose content of as much as about 75%, may also be useful in producing compositions of the present invention. It can be conceived that by mixing the different starches, amylose ranges from between about 40% to about 90%, between about 40% to about 80%, between about 40% to about 70%, between about 40% to about 60%, between about 40% to about 50%, between about 50% to about 90%, between about 60% to about 90%, between about 70% to about 90%, and between about 80% to about 90% can be used in the present invention. Further, it can be conceived that by mixing the different starches, amylose ranges from between 40% to 90%, between 40% to 80%, between 40% to 70%, between 40% to 60%, between 40% to 50%, between 50% to 90%, between 60% to 90%, between 70% to 90%, and between 80% to 90% can be used in the present invention.

In their native states, starches take the form of granules whose size and shape are characteristic of the plants from which they are derived. These granules are largely insoluble in water at ambient temperatures and, therefore, must be dispersed in aqueous solution in order to produce the water-resistant glass-like polysaccharide abrasive grit particles of the present invention. The process of dispersing starches is known as “gelatinization.” Gelatinization occurs when an aqueous mixture of starch granules is heated until the starch granules are disrupted, ultimately dispersing into solution and creating a viscous mass or gel.

In another embodiment, the present invention relates to a process of making the glass-like polysaccharide of the present invention comprising the steps of: heating an aqueous dispersion of polysaccharides having an average amylose content of at least about 45% by weight, or in the ranges discussed above, at an elevated temperature and time sufficient to produce a gel; subdividing and cooling the gelatinized polysaccharides to form a glass-like solid material; and optionally grinding the glass-like solid material to form fragments of different sizes. The glass-like solid material forms without substantial volatilization of moisture, which is occluded within a matrix of polysaccharide molecules, producing grit particles having a moisture content from at least about 5% to about 30% by weight and a hardness of between about 1.0 moh and about 4.0 moh, between about 2.0 moh and about 4.0 moh, between about 3.0 moh and about 4.0 moh, between about 1.0 moh and about 3.0 moh, and between about 1.0 moh and about 2.0 moh. Further, this can produce grit particles having a moisture content from between 5% to 30% by weight and a hardness of between 1.0 moh and 4.0 moh, between 2.0 moh and 4.0 moh, between 3.0 moh and 4.0 moh, between 1.0 moh and 3.0 moh, and between 1.0 moh and 2.0 moh. As mentioned, the hardness value of the glass-like polysaccharide of the present invention based on the moh scale of hardness can be converted to equivalent values of other hardness scales used by those skilled in the art, such as the Brinnell scale, the Knoop scale, or the Vicker scale.

The aqueous dispersion of polysaccharides comprises polysaccharides with an average amylose content of at least about 45% by weight and desirably in which all of the polysaccharides have an amylose content of at least about 45% by weight. However, it is presently preferred that all polysaccharides within the aqueous dispersion of polysaccharides have an amylose content of at least about 50% by weight and in one form, at least about 70% by weight

In one preferred embodiment, the heating step is conducted by processing the aqueous dispersion of polysaccharides in an extruder apparatus. As mentioned, the extrusion apparatus can use a variety of sizes and shapes for the final shape and size of the extruded product. Further, during the extrusion process, the extruded product can be cut into various lengths, depending upon the final intended use of the product. Extrusion expedites the processing by allowing higher temperatures to be employed and by providing more thorough heating and mechanical working of the aqueous dispersion of polysaccharides. Moreover, gelatinized polysaccharides produced by extrusion are generally more uniform than those produced by, for example, batch gelatinization. However, because excessive mechanical working of the gelatinized polysaccharides can adversely affect the ability of the resulting polysaccharide or starch matrix to hold the water in a substantially occluded condition, the specific mechanical energy input to the polysaccharide gel during gelatinization is preferably within a range of about 0.05 to 0.2 Kw/kg.

In one embodiment, gelatinization of the high amylose polysaccharides requires an extrusion temperature of at least about 75 degrees C., but preferably proceeds at temperatures of up to about 120 degrees C. in the heating step. However, if temperatures in excess of the boiling point of water are used, the process should be carried out under pressure to preclude damage to the structure of the composition which would be caused by expansion of the water within the matrix of the polysaccharide molecules, prior to formation of the glass-like solid.

Upon cooling, the polysaccharide gel forms a glass-like solid material. The glass-like solid material is then dried to remove excess moisture. Drying may take place at ambient temperatures over at least a 24 hour period. It is presently preferred to dry the glass-like solid material using a continuous fluidized-bed dryer operating at a temperature of about 85 degrees C. to 95 degrees C. for a period of 45 minutes. Drying times of at least 45 minutes are used to prevent agglomeration of the glass-like solid material that may otherwise occur where shorter drying times and/or elevated drying temperatures are used. After drying, the glass-like solid material is preferably allowed to cool and cure for up to 24 hours or more.

After cooling and curing, the glass-like solid material may be further ground to an appropriate fragment size using a suitable apparatus, such as an impact mill. The size of the final product will be determined by the final intended use of the product. For example, it may be desired to have large fragments, in which case, no further grinding would take place. If a fine particle is desired, however, then grinding will occur for a duration that results in the desired particle size. Accordingly, abrasive grit materials can be produced according to a standard particle size, such as 12/60 mesh. This standard means that all of the particles will pass through 12 U.S. mesh but none will pass through 60 U.S. mesh. Fragment or particle sizes can also be measured using metric or other standard units of measurement. The fragment or particle is measured across the largest diameter.

In a preferred embodiment, ranges of these fragment sizes can be between about 0.1 to about 100.0 mm, between about 1.0 mm to about 100.0 mm, between about 3.0 mm to about 100.0 mm, between about 5.0 mm to about 100.0 mm, between about 10.0 mm to about 100.0 mm, between about 25.0 mm and about 100.0 mm, between about 50.0 mm and about 100.0 mm, between about 0.1 mm and about 50.0 mm, between about 0.1 mm and about 25.0 mm, between about 0.1 mm and about 10.0 mm, between about 0.1 mm and about 5.0 mm, and between about 0.1 mm and about 3.0 mm.

In another preferred embodiment, ranges of these fragment sizes can be between 0.1 to 100.0 mm, between 1.0 mm to 100.0 mm, between 3.0 mm to 100.0 mm, between 5.0 mm to 100.0 mm, between 10.0 mm to 100.0 mm, between 25.0 mm and 100.0 mm, between 50.0 mm and 100.0 mm, between 0.1 mm and 50.0 mm, between 0.1 mm and 25.0 mm, between 0.1 mm and 10.0 mm, between 0.1 mm and 5.0 mm, and between 0.1 mm and 3.0 mm.

A variety of starches may be used to produce the glass-like polysaccharide grits of the present invention. As stated, the use of starches with higher amylose content, such as the genetically engineered corn starches Hylon V and Hylon VII, typically requires a much higher gelatinization temperature than do starches derived from common cultivated plants. For example, the gelatinization temperature of common corn starch ranges from about 62 degrees C. to 72 degrees C., while common wheat starch typically requires a temperature of about 58 degrees C. to 64 degrees C. In contrast, Hylon V (55% amylose) minimally requires a gelatinization temperature of about 70 degrees C. to 88 degrees C., while Hylon VII (70% amylose) minimally requires a temperature of about 72 degrees C. to 92 degrees C., at ambient pressures.

The moisture contents of the glass-like polysaccharide grits may also be varied. Varying the moisture content affects the apparent hardness and integrity of the glass-like polysaccharide grits. In general, the more water that is present in the glass-like polysaccharide, the greater the resiliency of the resulting material, the lower the apparent hardness and the less aggressive the abrasive grit product. On the other hand, the lower the moisture content of the glass-like polysaccharide, the more brittle the material is likely to be, with a resultant loss of particle integrity, namely a greater rate of particle breakdown and therefore, higher grit costs to the user. Moreover, thermal hydrolysis of the polysaccharides is more likely to occur at a low moisture content, which is not generally desirable. Thus, although it is possible to achieve a moisture content as low as 5%, the moisture content of the glass-like polysaccharides is preferably between about 10% to about 30% by weight and most preferably, in the range of about 10% to about 20% by weight.

The apparent hardness and integrity of the glass-like polysaccharide grits may also be affected by hydrolytic modification of the starch. The length of the polysaccharide polymers affects the molecular forces which play a role in forming the glass-like polysaccharides. Starches which have been hydrolytically modified form glass-like polysaccharides which are generally more brittle than glass-like polysaccharides based on comparable unhydrolysed starches. Thus in one form of the present invention, the aqueous dispersion of polysaccharides comprises a starch with a dextrose equivalent of about 10 or less and more preferably, a starch which is substantially unhydrolysed (i.e. having a dextrose equivalent of about 1 or less).

The non-limiting Examples herein below are illustrative of methods of producing the glass-like polysaccharides of the invention, and also of methods of using the glass-like polysaccharides of the invention.

### EXAMPLES

### Example 1

A cross-linked glass-like starch was prepared in accordance with this example, using a Werner & Pfleiderer C-37 twin screw extruder having a screw diameter of 37 mm and a processing barrel length of about 900 mm. The processing barrel was equipped with three temperature control zones, z1, z2, and z3 respectively. The first zone was a feed zone adapted to receive both dry and liquid feeds of the various raw materials used in this example. The second zone was a mixing zone incorporating two pairs of 30 degree right-handed kneading blocks in known manner. The third zone contained only conveying elements. A low intensity screw and a die plate having two 4 mm holes therein were used. The temperature of the product was maintained at below 110 degrees C. as it entered the die plate, but the die itself was neither heated nor cooled. A face cutter was used to cut the extrudate as it exited from the die plate, into pellets approximately 0.2 to 0.5 cm in length.

Starch (sold by Ogilvie Mills Limited under the trade mark Whetstar-4), water, 0.04% sodium hydroxide, 0.04% sodium trimetaphosphate and 0.04% calcium carbonate (all on a dry weight of starch basis), were fed to the extruder through the dry feed port and liquid feed port respectively at a total throughput of 8.6 kg/hr with a moisture content of 20%. The screw speed was maintained at 100 rpm and the temperature was controlled by heating each of the respective zones as follows:

z1(150 mm): 10-15 degrees C.

z2(450 mm): 50 degrees C.

z3(300 mm): 80 degrees C.

These extrusion conditions resulted in a glass-like starch product having a temperature of 103 degrees C. and a die pressure of 410 psi. A non-expanded, fully gelatinized product, having a light brown/yellow coloration, was produced within a matter of minutes which became hard and glass-like on standing under normal ambient conditions.

### Example 2

The following example describes a process for making a cross-linked glass-like polysaccharide utilizing a batch processing method. A slurry was prepared by dispersing 40% starch by weight in water, together with 0.04% epichlorhydrin and 0.04% sodium hydroxide (both based on the dry weight of starch), and then cooked until the starch was fully gelatinized. The resulting gel was poured to a depth of one half inch in a pan and dried for 2 hours in a forced air oven at 95 degrees C. After the first half hour of drying the product was removed from the oven and broken into small pieces, and then returned to complete the drying cycle. The resulting product was non-expanded, fully gelatinized and had a light brown-yellow coloration.

### Example 3

The process according to example 2 was repeated, with 0.04% sodium tripolyphosphate substituted for the epichlorhydrin used in the preceding example. The resulting product also was non-expanded, fully gelatinized, and had a light brown-yellow coloration.

The preceding three examples, in addition to being cross-linked, are also examples of solid, annealed, glass-like starch-based materials which are normally transparent or translucent, and which remain solid under standard ambient temperature and pressure conditions, and wherein moisture contained in the material is substantially occluded within the interstices of a matrix of starch molecules.

Examples of other such glass-like starch-based materials, which are not cross-linked are contained in Examples 4 through 8, below. For convenience, reference is made hereinafter to types of products in accordance with the following chart:

Type A product—starch, water and sodium hydroxide

Type B product—starch and water

Type C product—starch, water, sodium hydroxide, calcium carbonate and sodium trimetaphosphate.

Type I product—starch and water blend with silica gel

### Example 4

A preferred Type B, glass-like starch is prepared in accordance with this example, using a Werner & Pfleiderer C-37 twin screw extruder having a screw diameter of 37 mm and a processing barrel length of about 900 mm. The processing barrel was equipped with three temperature control zones, z1, z2, and z3 respectively. The first zone was a feed zone adapted to receive both dry and liquid feeds of the various raw materials used in this and the succeeding twin screw extruder examples. The second zone was a mixing zone incorporating two pairs of 30 degree right handed kneading blocks in known manner. The third zone contained only conveying elements. A low intensity screw and a die plate having two 4 mm holes therein were used. The temperature of the product was maintained at below 110 degrees C. as it entered the die plate, but the die itself was neither heated nor cooled. A face cutter was used to cut the extrudate as it exited from the die plate, into pellets approximately 0.2 to 0.5 cm in length.

Starch (sold by Ogilvie Mills Limited under the trade mark Whetstar-4) and water were fed to the extruder through the dry feed port and liquid feed port respectively at a total throughput of 8.6 kg/hr with a moisture content of 22%. The screw speed was maintained at 100 rpm and the temperature was controlled by heating each of the respective zones as follows:

z1(150 mm): 10-15 degrees C.

z2(450 mm): 50 degrees C.

z3(300 mm): 80 degrees C.

These extrusion conditions resulted in a glass-like starch product having a temperature of 103 degrees C. and a die pressure of 410 psi. A non-expanded, fully gelatinized product was produced within a matter of minutes which became hard and glass-like on standing under normal ambient conditions.

### Example 5

The following example illustrates the production of a Type A glass-like starch, using the same extruder that is described in the preceding example. The 20% moisture/starch mixture included 0.04% sodium hydroxide (based on the dry weight of the starch). The mixture was processed in accordance with the same processing conditions as are set out in the preceding example, and formed a product which was non-expanded, fully gelatinized, and had a light brown-yellow coloration.

### Example 6

The following is an example of the production of a Type C product. The extruder and processing were the same as for the two preceding examples. The mixture was the same as for example 2, but further included 0.04% sodium trimetaphosphate and 0.04% calcium carbonate (both on a dry weight of starch basis). The resulting product was similar in appearance to the Type A product described in example 5.

### Example 7

The following details the production of a Type B product using a single screw extruder having a barrel diameter of 25.4 mm and a 625 mm processing barrel, divided into three temperature control zones of equal length. The zones are heated to 50, 100 and 100 degrees C., respectively. The mixture comprised 23% moisture by total weight, and was extruded at a rate of 1.68 Kg/hr at a screw rotational speed of 50 rpm. The resulting product was similar in appearance to that of example 4.

### Example 8

The following example describes a method for making a Type B product utilizing a batch processing method. A slurry was prepared by dispersing 40% starch by weight in water, and then cooked until the starch was fully gelatinized. The resulting gel was poured to a depth of one half inch in a pan and dried for 2 hours in a forced air oven at 95 degrees C. After the first half hour of drying the gel was removed from the oven and broken into small pieces, and then returned to complete the drying cycle. The resulting product was similar in appearance to the product of example 4.

### Example 9

The extruded pellets prepared in the preceding examples from non-cross-linked glass-like starch-based materials were ground to form abrasive grit materials after having been allowed to cool and cure for a minimum of 24 hours. The cooled and cured pellets were then processed in a Raymond Laboratory Hammer Mill which was operated without a screen. The pellets were fed into the mill at about 20 pounds per hour. The material was passed through a 12 US mesh screen and approximately 30% of the total mass passed through the screen upon first pass through the mill. The remaining 70% was then cycled through a second pass and about 35% of the original mass was till retained on the 12 US mesh screen, which material was then passed through a third cycle. Following the third pass only about 1% of the original mass was still retained on the screen and the final particle size distribution was as follows:

| | % BY WEIGHT |
|---|---|
| MESH | RETAINED ON SCREEN |
| 12 | 1% |
| 20 | 63% |
| 30 | 18% |
| 40 | 10% |
| 60 | 6% |
| undersized | 2% |

### Example 10

Extruded pellets comparable to those used in Example 9 were ground to form abrasive grit materials after having been allowed to cool and cure for a minimum of 24 hours. The cooled and cured pellets were then processed in a Pallmann paddle mill. Both grinding plates were kept stationary and the gap between the plates and the paddles was adjusted to the maximum. The grinding rate was adjusted to about 200 pounds per hour and the operating temperature was about 43 degrees C. The product exiting the mill was sieved through a number 14 US mesh screen and the overs were recycled through the mill until the final particle size distribution was as follows:

| | % BY WEIGHT |
|---|---|
| MESH | RETAINED ON SCREEN |
| 12 | 0% |
| 30 | 81.9% |
| 50 | 16.4% |
| undersized | 1.7% |

### Example 11

Glass-like polysaccharide grit particles were prepared in accordance with this example, using a Buss Kneader single screw extruder equipped with a low intensity screw to minimize the mechanical energy imparted to the product. The screw diameter was 140 mm and the extruder barrel had a length of about 1540 mm. A crosshead extruder was present at the end of the extruder barrel, with a die plate having 169 holes of 3.6 mm in diameter. A face cutter equipped with two knives operating at 5 rpm was used to cut the polysaccharide gel into pellets as it exited from the die plate.

The extruder barrel was provided with two processing zones. The first processing zone was a feed zone having dry and liquid feed ports through which both dry starch and liquid water feeds were introduced. The second processing zone contained a combination of screw mixing elements for mixing and heating the product. The crosshead extruder contained a non-compression screw with only conveying elements.

The extruder barrel was further equipped with three independent temperature control zones, comprising z1, the water heated screw, and z2 and z3, which were oil heated zones along the processing barrel. The crosshead extruder was equipped with two temperature control zones, comprising z4, the water heated screw, and z5, the oil heated crosshead barrel.

Temperature control zones z1, z2, z3, z4, and z5 were monitored by thermocouples t1, t2, t3, t4, t5 respectively. Thermocouple t6 was placed just before the die plate to measure the temperature of the polysaccharide gel at the die plate. The temperature control zones were adjusted to provide a gradual increase in temperature as the process of gelatinization proceeded along the length of the extruder.

The various temperature zones were controlled so that t6 did not exceed 120 degrees C.

Hylon V, a high amylose corn starch available from National Starch Co. with approximately 55% amylose content, was fed into the extruder through the dry feed port at a total throughput rate of approximately 360 kg/hr. Water was fed into the liquid feed port of the extruder to obtain a moisture content of approximately 25% by weight of the raw material feed. The extruder barrel screw speed was maintained at 115 rpm and the temperature was controlled by heating each respective temperature control zone to obtain the following temperatures:

t1: 70-72 degree C.

t2: 88-89 degree C.

t3: 103-108 degree C.

t4: 100-110 degree C.

t5: 94-103 degree C.

t6: 105-111 degree C.

These extrusion conditions resulted in an almost fully gelatinized starch with a translucent yellow coloration, having a temperature of 105 degree C.-111 degree C. and a die pressure of between 80 and 120 psi at the die plate. The gelatinized starch was cut into pellets of approximately 2.0 to 5.0 mm in length by the face cutter as it exited from the die plate. The pellets were gradually brought to a moisture content of about 13%-15% by feeding them to a continuous fluidized-bed dryer operating at 105 degree C. Sufficient time was given during drying and post-extrusion handling of the pellets to prevent agglomeration of the pellets. A pellet classifier was used to separate fines or broken pellets from whole pellets.

The Rockwell hardness of the dried pellets was measured a minimum of 24 hours after extrusion and ranged from 72 to 86 on a Shore D scale.

### Example 12

Glass-like polysaccharide grit particles were prepared using a corn starch of higher amylose content. Using the same extruder as described in Example 1, Hylon VII (National Starch Company), a high amylose corn starch with approximately 70% amylose content, was fed into the dry feed port of the extruder at a total throughput rate of approximately 660 kg/hr. Water was fed into the liquid feed port of the extruder to obtain a moisture content of approximately 25% by weight of the raw material feed. The screw speed was maintained at 115 rpm and the temperature was controlled by heating each respective zone along the length of the extruder as follows:

t1: 48-53 degree C.

t2: 58-61 degree C.

3: 57-58 degree C.

4: 84-85 degree C.

5: 102-107 degree C.

6: 109-120 degree C.

These extrusion conditions resulted in an almost fully gelatinized starch with a translucent yellow coloration, having a temperature of 109 degree C.-120 degree C. and a die pressure ranging from 990 to 1050 psi at the die plate. The gelatinized starch was then cut into pellets of approximately 1.5 to 2.5 mm in length by the face cutter as it exited from the die plate. The pellets were gradually brought to a moisture content of about 11%-13% by feeding them to a continuous fluidized-bed dryer operating at a temperature range of 123 degree C.-132 degree C. Sufficient time was given during post-extrusion handling and drying of the pellets to prevent agglomeration of the pellets. A pellet classifier was used to separate fines or broken pellets from whole pellets.

The Rockwell hardness of the dried pellets was measured a minimum of 24 hours after extrusion and ranged from 75 to 82 on a Shore D scale.

### Example 13

The dried pellets produced in Example 1 were allowed to cool and cure for a minimum of 24 hours, then ground to form grit particles using a Pallmann Type PP8 impact mill available from Pallmann Maschinenfabrik GmbH & Co. KG, Wolfslochstrasse 51, Postfach 1652, Germany. Both grinding plates of the mill were kept stationary and the gap between the plates and the paddles of the mill was adjusted to the maximum. The dried pellets were fed into the impact mill at a grinding rate of approximately 450 kg/hr and the operating temperature was kept below 45 degree C.

The grit particles exiting the impact mill were sieved through a number 15 U.S. mesh screen and the overs were recycled through the impact mill. The grit particles were further sieved through a multiple deck sifter to yield two final grit particle distributions. These two grit particle distributions will be referred to as Type A 12/30 and Type A 30/50, to reflect the different sizes of the grit particles in each distribution. The particle size distribution data is as follows:

| | |
|---|---|
| Mesh size | % by weight retained on screen |

Type A 12/30

| | |
|---|---|
| 12 | 4.0% |
| 16 | 42.9% |
| 20 | 39.6% |
| 25 | 8.3% |
| 30 | 3.7% |
| +30 | 1.5% |

Type A 30/50

| | |
|---|---|
| 30 | 2.9% |
| 35 | 28.0% |
| 40 | 36.6% |
| 50 | 30.7% |
| +50 | 1.8% |

### Example 14

The dried pellets produced in Example 2 were allowed to cool and cure for a minimum of 24 hours, ground to form grit particles using a Pallmann Type PP8 impact mill and then sieved through a 15 U.S. mesh screen in the same manner as described in Example 3, with the overs being recycled through the impact mill.

The grit particles were then further sieved through a multiple deck sifter to yield two final grit particle distributions. These two grit particle distributions will be refered to as Type B 12/30 and Type B 30/50, to reflect the different sizes of the grit particles in each distribution. The particle size distribution data is as follows:

Type B 12/30

| Mesh size | % by weight retained on screen |
|---|---|
| 12 | 6.7% |
| 16 | 49.5% |
| 20 | 31.4% |
| 25 | 2.6% |
| 30 | 8.8% |
| +30 | 1.0% |

Type B 30/50

| Mesh size | & by weight retained on screen |
|---|---|
| 30 | 3.0% |
| 35 | 36.8% |
| 40 | 32.4% |
| 50 | 25.9% |
| +50 | 1.9% |

The high amylose glass-like polysaccharide grit particles of the present invention possess several advantageous physical properties in comparison to the prior art polysaccharide grits described in U.S. Pat. No. 5,367,068, including water-resistance, a high degree of fluorescence to the unaided eye when viewed under ultraviolet light, more efficient paint stripping rates, and lower breakdown rates. In addition to these advantageous qualities, the abrasive grit particles of the present invention retain the suitability for use as blast media for aluminum clad and composite materials and the nontoxic/biodegradeable qualities of the prior art polysaccharide grits.

The polysaccharide grit particles of the present invention exhibit water-resistance, by which it is meant that even after substantial exposure to liquid water for an extended period of time, the grit particles maintain their particulate character and recover their usability as blast media upon drying. In contrast, the prior art polysaccharide grit particles tend to cake and agglomerate, losing their particulate integrity and forming a non-particulated mass after contact with liquid water.

### Example 15

The water-resistance of the high amylose Type A 12/30 grit particles described in Example 3, Type B 12/30 grit particles described in Example 4, and Type B 16/60 grit particles prepared by the same procedure described in Examples 2 and 4, was compared to commercially available ENVIROSTRIP™ Starch Media (ADM/Ogilvie) 12/30 and 12/80, and POLYMEDIA LITE™ 75 20/50 grit particles (U.S. Technology Corp.). The ENVIROSTRIP™ 12/30 and 12/80 grit particles are based on typical unmodified wheat starch with an amylose content of about 28% by weight, prepared in accordance with the prior art U.S. Pat. Nos. 5,367,068. POLYMEDIA LITE™ 75 20/30 grit particles are based on typical wheat starch modified by grafting an acrylic polymer onto the polysaccharide backbone, as described in U.S. Pat. No. 5,780,619.

The water-resistance of each specimen of grit particles was measured by weighing approximately two grams of grit particles to the nearest 0.0001 gram and placing them in a preweighed centrifuge tube. The grit particles were then wetted by adding 40 ml of distilled water to each centrifuge tube. After shaking the tube vigorously, the suspension of grit particles in water was allowed to stand 10 minutes. During this time, the tubes were inverted 3 times at the 5 and 10 minute marks. Each tube sample was then centrifuged at 3500 rpm for 15 minutes. The supernatant or remaining water was then carefully decanted without disturbing the top layer of the wetted sample and the total weight of the tube and sample was recorded. The weight of the wetted sample was then calculated by subtracting the known weight of the tube. The hydration capacity, or ability to absorb water, was measured as the difference in sample weight before and after wetting, divided by the original weight of the sample.

The high amylose Type A 12/30, Type B 12/30, and Type B 16/60 polysaccharide grit particles absorb substantially less water when compared to commercial ENVIROSTRIP™ 12/30 and 12/80, and POLYMEDIA LITE™ 75 20/50 grit particles. The following hydration capacity results were obtained for Type A 12/30, Type B 12/30, Type B 16/60, ENVIROSTRIP™ 12/30 and 12/80, and POLYMEDIA LITE™ 75 20/50 grit particles, tested as described above.

Comparison of Hydration Capacity of Type A 12/30,
Type B 12/30 and 16/60, ENVIROSTRIP ™ 12/30 and 12/80

| Abrasive Grit | Hydration Capacity at 25. degree. C. |
|---|---|
| Type A 12/30 | 3.2 |
| Type B 12/30 | 3.1 |
| Type B 16/60 | 3.3 |
| ENVIROSTRIP ™ 12/30 | 6.9 |
| ENVIROSTRIP ™ 12/80 | 6.5 |
| POLYMEDIA LITE ™ 75 20/50 | 7.8 |

In addition to their increased resistance to absorption of water, the high amylose Type A 12/30, Type B 12/30, Type B 16/60 high amylose grit particles maintain their integrity upon exposure to liquid water, even for an extended period, retaining their usability as blast media after being dried. The prior art ENVIROSTRIP™ 12/30 and 12/80 grit particles, as well as the starch/acrylic POLYMEDIA LITE™ 75 20/50 grit particles, all tend to cake and agglomerate upon exposure to limited amounts of water, where the grit particles are present in excess. However, when immersed in excess of water, the ENVIROSTRIP™ 12/30 and 12/80 grit particles and POLYMEDIA LITE™ 75 20/50 grit particles tend to swell and form a fragile gel which readily disperses into a cloudy solution when disturbed. Thus, the ENVIROSTRIP™ 12/30 and 12/80 grit particles and POLYMEDIA LITE™ 75 20/50 grit particles are no longer useable as blast media after contact with or immersion in water, even after being dried.

In contrast, the high amylose grit particles of the present invention retain their particulate character after contact with or immersion in liquid water and may be used as blast media after drying. It has been found that, even after immersion in liquid water for two weeks, the Type A 12/30 grit particles retained their integrity and were usable as grit media after drying.

The increased water-resistance of the high amylose grit particles eliminates the need for special precautions to exclude moisture from blasting apparatus and allows the abrasive grit particles of the present invention to be used as “drop-in” replacements for prior art plastic bead media used with conventional blasting apparatus. In contrast, the commercially available ENVIROSTRIP™ 12/30 and 12/80 and POLYMEDIA LITE™ 75 20/50 grit particles require high quality dry compressed air to be fed to specially designed blast equipment. These precautions are needed in order to avoid any operational problems caused by moisture condensation forming within blasting equipment or pressurized vessels.

### Example 16

Another advantageous feature of the grit particles described in the present invention is that they exhibit a high degree of visible fluorescence to the unaided eye when viewed under ultraviolet light or “black light.” Thus, when viewed under ultraviolet light, the high amylose Type A 12/30 and Type B 12/30 grit particles described in Examples 3 and 4 exhibit a high degree of fluorescence which is easily visible to the unaided eye. Such a degree of fluorescence is useful in that it facilitates the inspection of objects or surfaces treated with polysaccharide blast media for infiltration of the blast media into masked or sealed areas. It may also help in confirming that the treated surface is intact and does not contain small cracks or areas filled with blast media.

The prior art ENVIROSTRIP™ 12/30 grit particles exhibited a degree of fluorescence, which was observedly less intense than that of the high amylose Type A 12/30 and Type B 12/30 grit particles. POLYMEDIA LITE™ 75 20/50 starch/acrylic grit particles exhibited a degree of fluorescence which was weaker than that observed for ENVIROSTRIP™ 12/30 grit particles. Type V PolyPlus 20/40 Plastic Abrasive (U.S. Technology Corp.) was not visibly fluorescent to the unaided eye. Thus, in contrast to the high amylose Type A 12/30 and Type B 12/30 grit particles, the more limited degrees of fluorescence exhibited by the ENVIROSTRIP™ 12/30 grit particles and the POLYMEDIA LITE™ 75 20/50 grit particles is not likely to be as useful in facilitating the inspection of objects for infiltration or intrusion of blast media.

### Example 17

Steel parts are manufactured using techniques that would be apparent to one skilled in the manufacturing arts. Examples of these parts, but not limited to, are washers, screws, nuts, bolts, nails, rivets, gears, cogs, sprockets, bushings, shafts, clevises, or the like. To prepare their surface for galvanization, oxidation and residual elements from the manufacturing and subsequent washing processes must be removed. The parts are placed in a vibratory tub apparatus that is filled with glass-like polysaccharide fragments sized between about 0.5 mm and about 5.0 mm as measured across the largest diameter. The size of the fragments can be varied, depending on the desired final effect on the steel parts. The parts are treated for between about 2.0 hours and about 6.0 hours, resulting in a surface that is substantially free of moisture, oxidation and residual elements from the manufacturing process.

Optionally, the parts can be made of lead, copper, brass, bronze, or other metals that would benefit from the treatment described above.

Optionally, the parts can be treated in different finishing apparatuses, with the apparatus chosen based on desired final finishing characteristics, and/or the size of the part. Examples, but not limited to, are vibratory bowls, centrifugal disc finishers, centrifugal barrel finishers, spindle machines, drag machines, vibratory mill, a ball mill, an agitator mill, an attrition mill, a roller ball mill, a bead mill, a planetary mill, and a sand mill, a tumbler, a barrel tumbler, a burnisher, and a racetrack finisher.

### Example 18

Stainless steel parts are manufactured using techniques that would be apparent to one skilled in the manufacturing arts. Examples of these parts, but not limited to, are washers, screws, nuts, bolts, nails, rivets, gears, cogs, pipe thread plug, pin, turnbuckle, shackle, pipe swagelock, or the like. To prepare the parts for final inspection and packaging, residual moisture and oils from the manufacturing process must be removed. The parts are placed in a heated vibratory tub apparatus that is filled with glass-like polysaccharide fragments sized between 3.0 mm and 10.0 mm as measured across the largest diameter. The size of the fragments can be varied, depending on the desired final effect on the parts. The temperature that the tub is heated to ranges from 80° C. to 150° C. The parts are vibrated for 5 hours, resulting in a surface that is substantially free of moisture and oils.

Optionally, the parts can be treated in different finishing apparatuses. Examples, but not limited to, are vibratory bowls, centrifugal disc finishers, centrifugal barrel finishers, spindle machines, drag machines, vibratory mill, a ball mill, an agitator mill, an attrition mill, a roller ball mill, a bead mill, a planetary mill, and a sand mill, a tumbler, a barrel tumbler, a burnisher, and a racetrack finisher.

### Example 19

Plastic parts are manufactured using techniques that would be apparent to one skilled in the manufacturing arts. An example, but not limited to, would be nylon bolts, washers, nuts, gears, cogs, sprockets, or the like. In this aspect, the glass-like polysaccharide fragments with sizes ranging between 0.5 mm and 3.0 mm act as a drying agent and also as an abrasive agent that removes minor manufacturing imperfections such as flash or burrs. Parts are placed in a vibratory tub apparatus and treated for between 1.0 hours and 3.0 hours. Because of the sensitivity of certain plastics to heat, the vibratory finishing apparatus would not be heated.

Optionally, the parts can be treated in different finishing apparatuses. Examples, but not limited to, are vibratory bowls, centrifugal disc finishers, centrifugal barrel finishers, spindle machines, drag machines, vibratory mill, a ball mill, an agitator mill, an attrition mill, a roller ball mill, a bead mill, a planetary mill, and a sand mill, a tumbler, a barrel tumbler, a burnisher, and a racetrack finisher.

### Example 20

A carbon fiber composite tube with a specified external diameter and a specified internal diameter is constructed using manufacturing processes apparent to those skilled in the art of composites manufacturing. Using a wet saw, the carbon fiber tube is cut to lengths ranging from 1.0 mm to 30.0 mm for use as headset spacers on a bicycle. The spacers are then added to a barrel tumbler containing the glass-like polysaccharides of the invention, in sizes ranging from between 3.0 mm and 10.0 mm as measured across their largest diameter. The spacers are then tumbled at speeds ranging between 1 and 50 revolutions per minute for between about 1 and about 4 hours. No additional heat is provided, due to the sensitivity of carbon composite resins to high heat. The glass-like polysaccharide of the invention acts as both a drying agent, removing residual moisture from the carbon fiber spacers, and a mild abrasive agent, smoothing the rough edges that result from the wet saw cuts, producing a finished product ready for inspection and packaging.

### Example 21

Metal wristwatch cases are cast and milled using manufacturing processes apparent to those skilled in the art. The watch cases can be made of stainless steel, titanium, gold, silver, or other metals used in watch cases. The watch cases are added to a vibratory bowl apparatus that is filled with stainless steel beads having diameters of 1.0 mm, and also containing the glass-like polysaccharide of the invention in sizes ranging between 1.0 mm and 5.0 mm as measured across the largest diameter, and a polishing or burnishing compound suitable for use on metals. The watch cases are treated for approximately 5 hours, with the result being a lustrous, shot-peened finish substantially free of residual liquids.

### Example 22

Brass bullet shell casings are prepared using manufacturing processes apparent to those skilled in the art. The shell casings must be clean and dry prior to being manufactured into completed bullets. The shell casings are added to a vibratory apparatus or tumbling apparatus that is filled with the glass-like polysaccharide of the invention in sizes ranging between 0.5 mm and 2.0 mm as measured across the largest diameter, and treated for between about 1.0 and about 5.0 hours. After treatment, the brass bullet shell casings are substantially free of residual liquids and minor surface dirt and oxidation.

### Example 23

After cutting and shaping of precious or semi-precious gemstones using traditional wet saw methods apparent to those skilled in the art, the stones are placed in a bead mill that is filled with stainless steel beads having diameters of 1.0 mm, and also containing the glass-like polysaccharide of the invention with sizes ranging between 0.5 mm and 5.0 mm, and a polishing compound suitable for use on gemstones. The gemstones are tumbled for 12-24 hours, with the result being a polished gemstone that is substantially free of residual oils or liquids.

### Example 24

Stainless steel or titanium tubing designed for the transport of fluids is manufactured using processes apparent to one skilled in the art, with a specified internal diameter of the tubing ranging from between about 0.5 m to about 5.0 m, for example. In certain applications, such as food processing plants, nuclear power plants, petroleum plants, chemical plants or desalinization plants, a high degree of cleanliness and purity is desired on the finished surfaces of the tubing. The glass-like polysaccharide of the invention, with fragment sizes of approximately 100 mm as measured across the largest diameter, is added to the inside of a section of manufactured tubing. The larger fragment sizes impart greater energy to the internal surfaces of the tubing being treated, thus having a greater effect on the internal surface of the tubing during a given period of time. Additionally, the larger fragments will break into smaller fragments during the course of treatment, thus gradually transitioning to a gentler treatment during a given period of time. After the glass-like polysaccharide fragments are added to the inside of the section of tubing to be treated, the ends of the tubing are temporarily capped and the tubing is then rotated for 10-16 hours, resulting in a substantially dry interior of the tubing, along with removal of any surface contaminants and minor manufacturing imperfections. Optionally, ceramic, plastic or stainless steel beads, or the like, and/or a polishing compound can be added during the treatment process.

### Example 25

Stainless steel, titanium or ceramic prosthetic joint parts are manufactured using processes apparent to one skilled in the art. The prosthetic joint parts are placed in a vibratory finishing apparatus with the glass-like polysaccharide of the invention with sizes ranging between 0.3 mm and 3.0 mm, and treated for 2-6 hours. Optionally, additional abrasive or polishing compounds may be added during the treatment process. The resultant parts are substantially free of any moisture, oils, and minor surface irregularities.

### Example 26

Fiber reinforced ceramic missile components are manufactured using processes apparent to one skilled in the art (see for example, U.S. Pat. No. 6,460,807). The components are treated in a drag machine containing the glass-like polysaccharide of the invention with sizes between 1.0 mm and 10.0 mm, resulting in gentle smoothing of any surface irregularities, and also drying and removal of residual oils from the components.

### Example 27

Conventional painting processes for small parts involves applying a priming agent onto the parts using paint application or electrostatic powder coating techniques apparent to one skilled in the art, followed by gentle sandblasting to remove any irregularities in the dried priming agent. This requires containment cabinets and a great deal of labor in assuring all parts are treated properly. An improvement on this process is to use the glass-like polysaccharide fragments of the invention in any of the vibratory apparatuses described above. The parts are added to the apparatus with the glass-like polysaccharide grit of the invention ranging in sizes from between about 0.5 mm to about 3.0 mm as measured across the largest diameter, and briefly treated so that any irregularities in the dried priming agent are removed and the surface is prepared for the final paint finish.

### Example 28

Aluminum alloy automobile wheels are cast and machined using techniques apparent to one skilled in the art. Following the CNC machining process, the wheels must be dried and deburred, particularly if a subsequent painting step is to occur. The wheels are treated in a drag machine containing the glass-like polysaccharide of the invention ranging in sizes from between about 2.0 mm and about 20.0 mm as measured across the largest diameter, optionally containing additional aluminum polishing compounds and/or aluminum deburring agents. The resultant wheel is substantially deburred, dried, cleaned and polished.

### Example 29

Rubber o-rings are manufactured using techniques apparent to one skilled in the art. The manufacturing processes used may leave residual moisture, oils or chemicals on the o-rings. Because of their possible sensitivity to heat, they are treated using the glass-like polysaccharide of the invention ranging in size from between about 0.5 mm to about 3.0 mm as measured across the largest diameter, in a vibratory apparatus or tumbler apparatus as described above. The additional benefit is that due to the softness of the rubber, any seams or extrusion irregularities will be abraded away by the action of the glass-like polysaccharide abrasive grit during the treatment process. The resultant rubber o-rings are substantially free of all moisture or processing chemicals, and are free of surface imperfections that could alter their functionality.

### Example 30

Hand tools (e.g. box wrenches that are drop forged) are manufactured using conventional forging techniques apparent to one skilled in the art. To prepare their surface for further finishing treatments, such as galvanization or chrome plating, oxidation and residual elements from the manufacturing and subsequent washing processes must be removed. The parts are placed in a vibratory tub apparatus that is filled with glass-like polysaccharide fragments sized between about 0.5 mm and about 5.0 mm as measured across the largest diameter. The size of the fragments can be varied, depending on the desired final effect on the surface of the tools. The tools are treated for between about 2.0 hours and about 6.0 hours, resulting in a surface that is substantially free of moisture, oxidation and residual elements from the manufacturing process.

All publications mentioned hereinabove are hereby incorporated in their entirety by reference.

While the foregoing invention has been described in some detail for purposes of clarity and understanding, it will be appreciated by one skilled in the art from a reading of this disclosure that various changes in form and detail can be made without departing from the true scope of the invention and appended claims.

What is claimed is:

1. A method of treating a substance with a glass-like polysaccharide, wherein said treating comprises placing said substance in contact with said glass-like polysaccharide, and agitating for a period of time to produce a modified substance.

2. The method of claim 1, wherein said glass-like polysaccharide is in the form of fragments ranging in size from between about 0.1 mm to about 100 mm.

3. The method of claim 1, wherein said treating results in the removal of liquid from said substance.

4. The method of claim 1, wherein said treating modifies the form or finish of said substance.

5. The method of claim 4, wherein said modifying the form or finish is selected from the group consisting of deburring, degrading, abrading, grinding, sanding, polishing, buffing, cleaning, degreasing and burnishing.

6. The method of claim 1, wherein said substance is brought into contact with said glass-like polysaccharide in an apparatus selected from the group consisting of a vibratory mill, a ball mill, an agitator mill, an attrition mill, a roller ball mill, a bead mill, a planetary mill, and a sand mill, a vibratory finisher, a vibratory bowl finisher, a vibratory tub finisher, a centrifugal finisher, a centrifugal disc finisher, a centrifugal barrel finisher, a spindle finishing machine, a drag finishing machine, a tumbler, a barrel tumbler, a burnisher, and a racetrack finisher.

7. The method of claim 1, wherein said substance is selected from the group consisting of a metal or metal alloy, a plastic, a composite material, a glass or glass-like material, a ceramic or ceramic alloy, a rubber, and a mineral.

8. The method of claim 7, wherein said metal is selected from the group consisting of steel, stainless steel, iron, nickel, nickel alloys, aluminum, aluminum alloys, copper, titanium, zinc, scandium, nickel, tungsten carbide, lead, gold, silver, platinum, tin, brass, bronze and any alloys thereof.

9. The method of claim 7, wherein said plastic is selected from the group consisting of polypropylene, polystyrene, polyvinylchloride (PVC), acrylonitrile butadiene styrene (ABS), cellulose, acrylic, polyester, polycarbonate, acetyl, nylon, polyethylene, flouropolymers, polyphenylene oxide, polysulfone, polyetheretherketone (PEEK), polyetherimide, polyamide-amide, polyimide, PBI, fiberglass and garolite.

10. The method of claim 7, wherein said composite material is selected from the group consisting of carbon fiber composites, kevlar fiber composites, boron fiber composites, and fiberglasses.

11. The method of claim 7, wherein said rubber is selected from the group consisting of latex, pure gum rubber, nitride, styrene-butadiene rubber, neoprene, epichlorohydrin, butyl, EPDM, hypalon, silicone rubber, polyurethane, santoprene, vinyl and viton.

12. The method of claim 7, wherein said glass is selected from the group consisting of borosilicate glass, silica glass, glass-ceramic, soda lime glass.

13. The method of claim 7, wherein said ceramic is selected from the group consisting of glass-mica ceramic, alumina bisque ceramic, boron-nitride ceramic, garolite-laminated ceramic, high alumina ceramic, zirconia ceramic, zirconium phosphate ceramic, alumina ceramic, silica ceramic, zirconium oxide ceramic, and silicon-nitride.

14. The method of claim 7, wherein said mineral is a precious or semiprecious stone.

15. A process for producing chemically cross-linked, polysaccharide fragments comprising the steps of:
(a) heating a homogeneous, aqueous mixture of dispersed polysaccharide molecules produced from starch and a chemical cross-linking agent to anneal the mixture whereby at normal ambient temperatures the mixture forms a solid product having a moisture content of between about 10 to about 70% by weight;
(b) reacting the chemical cross-linking agent with said polysaccharide molecules to produce intermolecular chemical cross-linkages between the polysaccharide molecules; and
(c) processing the solid product obtained thereby to form fragments having an apparent hardness of between about 1.0 moh and about 4.0 moh and sizes ranging between about 6.0 mm to about 100.0 mm.

16. A process for producing glass-like polysaccharide fragments comprising the steps of:
(a) providing an aqueous dispersion of polysaccharides produced from starch, said dispersion having an average amylose content ranging from between about 40% to about 90% by weight;
(b) heating said dispersion at a temperature and for a time sufficient to form a gel;
(c) subdividing and cooling the gel to form a glass-like solid material; and
(d) grinding the glass-like solid material to form glass-like polysaccharide fragments having an apparent hardness of between about 1.0 moh and about 4.0 moh, an average moisture content of at least about 5%, and sizes ranging between about 6.0 mm to about 100.0 mm.

17. The process according to claim 15, wherein step b) is carried out only after the mixture has formed into the solid product.

18. The process according to claim 15, wherein the starch is substantially unhydrolyzed.

19. The process according to claim 16, wherein the starch is substantially unhydrolyzed.

20. The process according to claim 15, wherein the starch has a dextrose equivalent ranging from about between 0 to 10.

21. The process according to claim 16, wherein the starch has a dextrose equivalent ranging from about between 0 to 10.

22. The process according to claim 15, wherein the starch has a dextrose equivalent ranging from about between 0 to 1.

23. The process according to claim 16, wherein the starch has a dextrose equivalent ranging from about between 0 to 1.

24. The process according to claim 15, wherein the starch is a corn starch or a wheat starch.

25. The process according to claim 16, wherein the starch is a corn starch or a wheat starch.

26. A product made by the process of claim 15.

27. A product made by the process of claim 16.

28. An isolated product comprising chemically cross-linked polysaccharide fragments or polysaccharide fragments having an average amylose content between about 45% and about 95% by weight, having a moisture content between about 5% and about 70% by weight, an apparent hardness between about 1.0 moh and about 4.0 moh, and fragment sizes ranging from between about 6.0 mm to about 100.0 mm.

29. The product according to claim 28, wherein said fragments comprise a starch having a dextrose equivalent ranging from about 0 to about 10.

30. The product according to claim 29, wherein said starch has a dextrose equivalent ranging from about 0 to about 1.

31. The product according to claim 28, wherein said starch is a corn starch or a wheat starch.

32. The product according to claim 28, further comprising other products for treating substances.

33. A method of treating a substance with a glass-like polysaccharide, wherein said treating comprises placing said substance in contact with said glass-like polysaccharide, and imparting motion to said substance being treated for a period of time to produce a modified substance.

34. The method of claim 33, wherein said glass-like polysaccharide is in the form of fragments ranging in size from between about 0.1 mm to about 100 mm.

35. The method of claim 33, wherein said treating results in the removal of liquid from said substance.

36. The method of claim 33, wherein said treating modifies the form or finish of said substance.

37. The method of claim 36, wherein said modifying the form or finish is selected from the group consisting of deburring, degrading, abrading, grinding, sanding, polishing, buffing, cleaning, degreasing and burnishing.

38. The method of claim 33, wherein said substance is brought into contact with said glass-like polysaccharide in an apparatus selected from the group consisting of a vibratory mill, a ball mill, an agitator mill, an attrition mill, a roller ball mill, a bead mill, a planetary mill, and a sand mill, a vibratory finisher, a vibratory bowl finisher, a vibratory tub finisher, a centrifugal finisher, a centrifugal disc finisher, a centrifugal barrel finisher, a spindle finishing machine, a drag finishing machine, a tumbler, a barrel tumbler, a burnisher, and a racetrack finisher.

39. The method of claim 33, wherein said substance is selected from the group consisting of a metal or metal alloy, a plastic, a composite material, a glass or glass-like material, a ceramic or ceramic alloy, a rubber, and a mineral.

40. The method of claim 39, wherein said metal is selected from the group consisting of steel, stainless steel, iron, nickel, nickel alloys, aluminum, aluminum alloys, copper, titanium, zinc, scandium, nickel, tungsten carbide, lead, gold, silver, platinum, tin, brass, bronze and any alloys thereof.

41. The method of claim 39, wherein said plastic is selected from the group consisting of polypropylene, polystyrene, polyvinylchloride (PVC), acrylonitrile butadiene styrene (ABS), cellulose, acrylic, polyester, polycarbonate, acetyl, nylon, polyethylene, flouropolymers, polyphenylene oxide, polysulfone, polyetheretherketone (PEEK), polyetherimide, polyamide-amide, polyimide, PBI, fiberglass and garolite.

42. The method of claim 39, wherein said composite material is selected from the group consisting of carbon fiber composites, kevlar fiber composites, boron fiber composites, and fiberglasses.

43. The method of claim 39, wherein said rubber is selected from the group consisting of latex, pure gum rubber, nitride, styrene-butadiene rubber, neoprene, epichlorohydrin, butyl, EPDM, hypalon, silicone rubber, polyurethane, santoprene, vinyl and viton.

44. The method of claim 39, wherein said glass is selected from the group consisting of borosilicate glass, silica glass, glass-ceramic, soda lime glass.

45. The method of claim 39, wherein said ceramic is selected from the group consisting of glass-mica ceramic, alumina bisque ceramic, boron-nitride ceramic, garolite-laminated ceramic, high alumina ceramic, zirconia ceramic, zirconium phosphate ceramic, alumina ceramic, silica ceramic, zirconium oxide ceramic, and silicon-nitride.

46. The method of claim 39, wherein said mineral is a precious or semiprecious stone.
